(19) United States
(12) Patent Application Publication
(10) Pub. No.: US 2005/0051106 A1
(43) Pub. Date: Mar. 10, 2005

(54) Modular pet furniture

(76) Inventors: Nancy Tulgren, Forest Lake, MN (US); Gregory Tulgren, Forest Lake, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/658,670

(22) Filed: Sep. 9, 2003

(51) Int. Cl. A01K 29/00

(52) U.S. Cl. 119/28.5

(57) ABSTRACT

Modular pet furniture providing a place for pets, in particular, cats, to rest, sleep and recreate, comprising a frame structure, a bed structure, a pet support and an attachment mechanism. The frame structure forms a single or a plurality of support regions or compartments that can accommodate different bed styles and different numbers of pets. The support regions also provide space for toys and other items of interest for pets, such as scratch pads. The modular pet furniture can be configured to contain a variable number of support regions in a number of different stacking configurations, to form pet furniture of a variety of shape and size.

### FIELD OF THE INVENTION

The present invention relates generally to a piece of furniture for pets. More particularly, the present invention relates to a piece of furniture of a modular, built-up design for pets, specifically cats.

### BACKGROUND OF THE INVENTION

In many situations, it is desirable to provide pet owners or boarders, especially those with multiple cats, an affordable, easy to install structure that can function as both a sleeping accommodation and recreational area for their pets. Even though it is possible for the owner or boarder to buy these items individually, the increased costs associated with purchasing multiple stand-alone individual components and the increased time and labor to put them together, as well as the additional space consumed make that a less than ideal situation.

The prior art includes several examples of modular rack type structures, such as U.S. Pat. Nos. 6,039,501; 5,743,412; 5,520,293; and 3,724,678. Likewise, cat toys such as cat scratch posts are set forth in U.S. Pat. Nos. 6,343,569; 5,054,429; and 3,993,027. Differing designs of cat beds have also been devised, such as those in U.S. Pat. Nos. D249,567 and D435,704.

While those inventions fulfill their respective, particular objectives and requirements, the aforementioned patents do not describe a combination modular pet bed and recreational structure that is simultaneously compact and space-saving as well as simple and inexpensive to construct.

For example, a conventional pet bed structure requires a certain amount of floor space. As more pets are housed, the need for floor space increases. While it may be possible to stack one or more of these conventional beds on top of each another, only the modular bed of the present invention is specifically suited for this purpose and permits stacking of multiple beds vertically in a structurally sound manner, increasing safety to the occupants while using considerably less floor space

Likewise, a conventional cat scratch post is comprised of particleboard or some other wood base with a textile outer covering. This structure is heavy and also more difficult, labor intensive, and expensive to construct. This prior design is, therefore, more costly to ship and after a period of use can become foul smelling, requiring periodic replacement of at least the outer covering.

In these respects, the cat scratch element of the present invention substantially departs from the conventional designs of the prior art, allowing for a lightweight, moveable, easily constructed alternative cat scratch post that can be quickly removed, cleaned as necessary, and returned to service.

### SUMMARY OF THE INVENTION

The present invention is a piece of modular pet furniture that includes space for a plurality of beds as well as toys, such as scratch pads, and other items of interest to pets. The modular pet furniture can be readily reconfigured to accommodate not only different bed styles but also different numbers of pets.

### BRIEF DESCRIPTION OF THE DRAWINGS

FIG. 1 is a perspective view of modular pet furniture according to the present invention.

FIG. 2 is a perspective view of a pet bed for use with the modular pet furniture.

FIG. 3 is a perspective view of an individual compartment for use with the modular pet furniture.

FIG. 4 is a perspective view of an alternative pet bed for use with the modular pet furniture.

FIG. 5 is a front view of a scratch pad for use with the modular pet furniture.

### DETAILED DESCRIPTION OF THE INVENTION

Modular pet furniture of the present invention is shown generally at 10 in the figures. The pet furniture 10 consists generally of a frame structure 20 defining separate compartments 40 that house various objects, such as cat beds, scratch pads, or other like items in a configuration most suitable to the occupants.

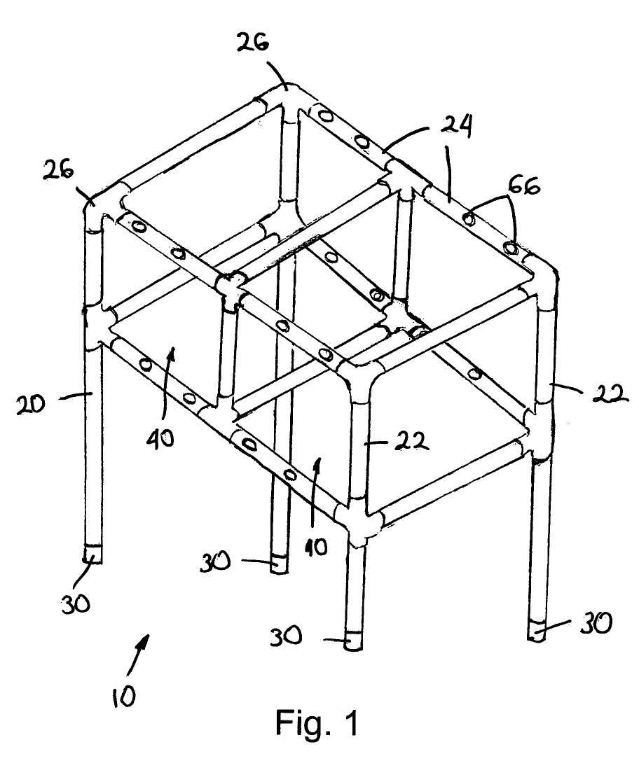

Referring to FIG. 1, the frame structure 20 includes a plurality of vertical support members 22, a plurality of horizontal cross members 24, and a plurality of joint members 26. The vertical support members 22 and horizontal cross members 24 are secured together using the joint members 26.

Elbows may be utilized at the top of the frame structure 20 to allow a smooth transition and enhanced appearance and to seal up end openings in the individual frame pieces. Likewise, the frame structure 20 preferably has caps 30 fastened at the ends of bottom vertical support members 22.

The joint members 26 are preferably manufactured with a traditional socket connection that is designed to accommodate the insertion of an end of vertical support members 22 or horizontal support members 24. This connection may be secured using PVC solvent cement, a set-screw fitting, a twist-lock connection, or other similar means of attachment depending on the permanency of the connection desired. Using a connection mechanism that permits disconnection of the components is preferred to facilitate reconfiguring the modular pet furniture 10.

The preferred material of construction for vertical support members 22, horizontal support members 24, and joint members 26 is PVC pipe, specifically schedule 40 PVC pipe. However, a person of ordinary skill in the art will appreciate that it is possible to use the concept of the present invention with other materials such as wood or metal.

The preferred embodiment of the present invention is in a kit form, with each kit consisting of the necessary pieces to construct a section of pet furniture consisting of two compartments 40, preferably stacked one compartment atop another. The modular attribute of the present invention is that multiple kits may be purchased and added to form a larger frame structure 20 having a plurality of compartments 40, depending on the needs of the user. Compartments 40 may be added both vertically and horizontally.

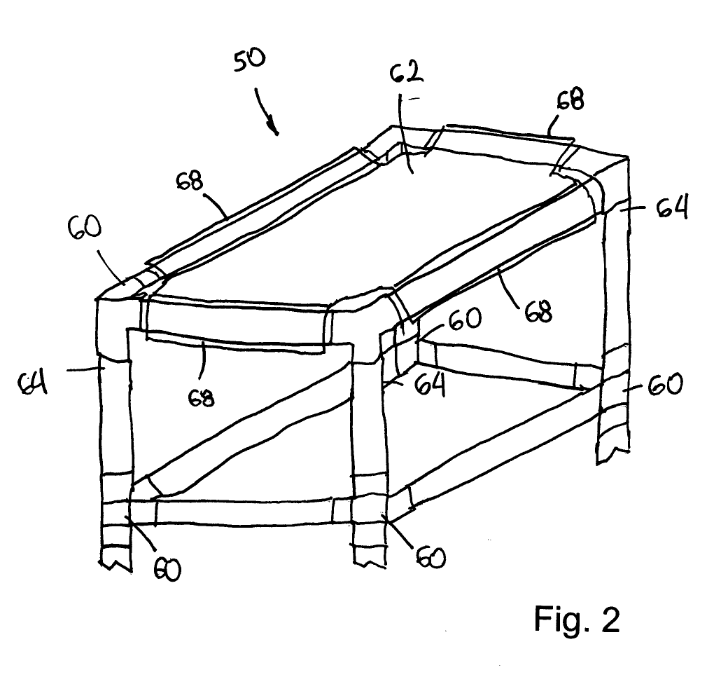

Referring to FIGS. 2-5, within the individual compartments 40 are one or more pet support structures, such as flat beds 50, partially enclosed beds 52, circular beds 54, scratch pads 56, or other recreational objects.

Each flat bed 50 is preferably fabricated from a bed frame 60 and a pet support surface 62. The bed frame 60 defines an outer perimeter that extends around the pet support surface 62. A plurality of support legs 64 extend from the bed frame 60 to facilitate attachment of the flat bed 50 to the frame structure 20 by extending the support legs 64 into apertures 66 formed in the horizontal support members 24.

The pet support surface 62 is preferably fabricated from fabricate which has a sleeve 68 formed along each edge thereof. Each of the sleeves 68 is adapted to receive one of the horizontal support members 24. To enhance the comfort of the pet support surface 62, a resilient pad (not shown) may be placed over the pet support surface 62. As an alternative to forming the bed substantially flat, the pet support surface may be curved (not shown) such as by using a portion of a large diameter section of pipe.

Alternatively, pad 60 may be fastened atop one or more sleeves (not shown) that fit over one or more horizontal cross beams 24 to secure the flat bed 50 to the frame structure 20.

Another feature of the modular design of the present invention is that flat beds 50 and circular beds 52 are offset vertically within compartments 40, allowing pets to navigate within the overall structure 20, regardless of the number of compartments 40 connected.

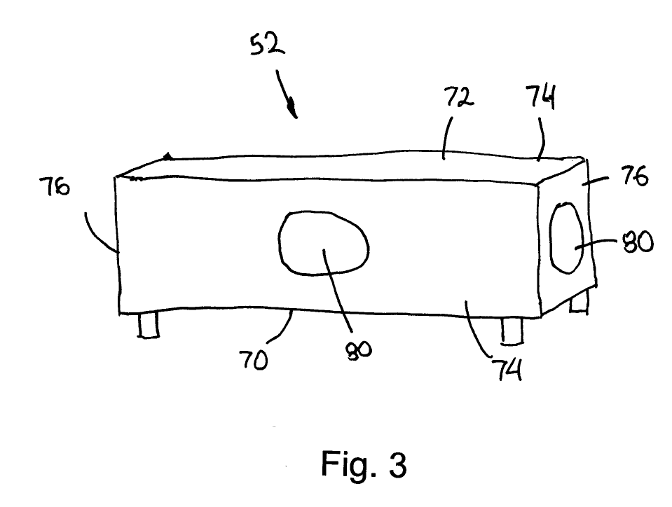

FIG. 3 illustrates a substantially enclosed bed 52 for use with the modular pet furniture 10. The substantially enclosed bed 52 preferably includes a lower panel 70, an upper panel 72, side panels 74, and end panels 76. At least one of the panels has an aperture 80 formed therein. The portion of the panel proximate the aperture 80 is preferably fabricated from a resilient material to permit the aperture to be stretched.

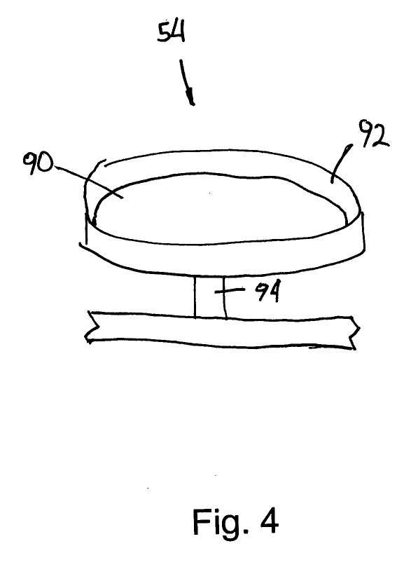

In another configuration, the pet support structure includes a circular bed 54, as illustrated in FIG. 4. The circular bed 54 preferably includes a support surface 90 and an upwardly directed outer rim 92 that extends around the support surface 90. A support leg 94 extends from a lower surface of the support surface 90 to facilitate attaching the circular bed 54 to the frame structure 20.

To enhance the comfort of the circular bed 54, a resilient pad or carpet piece (not shown) is preferably placed over the support surface 90. The circular bed 54 is particularly designed for attachment to one of the uppermost horizontal support members 24.

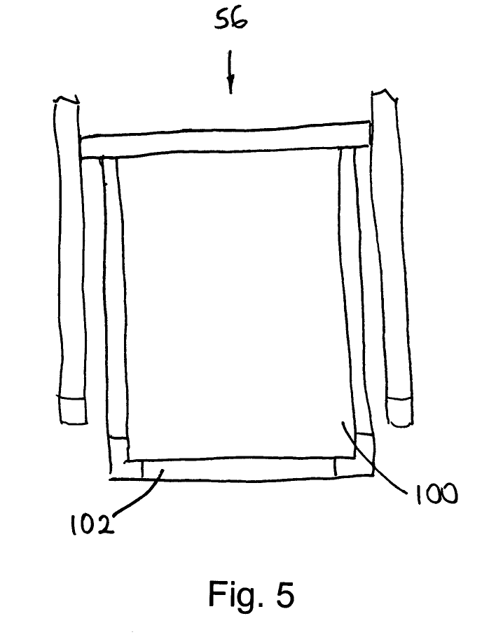

Referring to FIG. 5, a scratch pad 56 is shown in which a section of fabric or carpet 100 is connected to one or more sleeves 102 to form a surface for cats. This scratch pad 56 may be joined to either vertical support members 22 or horizontal support members 24 as described above.

In operation, vertical support members 22 and horizontal cross members 24 are secured to joint members 26 to form the frame structure 20 using one of the fastening methods described above. Once the frame structure 20 is completed, beds 50, 52, 54 or other components may be attached within individual compartments 40.

It is contemplated that features disclosed in this application, as well as those described in the above applications incorporated by reference, can be mixed and matched to suit particular circumstances. Various other modifications and changes will be apparent to those of ordinary skill and are subject to this disclosure.

1. Modular pet furniture comprising:
a frame structure comprising a plurality of vertical support members, each vertical support member having an insertion end, a plurality of horizontal support members, each of the horizontal support members having an insertion end, and a plurality of joint members for interconnecting the vertical support members and the horizontal support members to form an array, the joint members accommodating the insertion ends of the vertical support members and horizontal support members therewithin; and
a pet support structure comprising a pet support surface and an attachment mechanism operably attached thereto, wherein the attachment mechanism is removably attached to at least one of the vertical support members or the horizontal support members for maintaining the pet support surface in a position with respect to the frame structure.

2. The modular pet furniture of claim 1, wherein the attachment mechanism comprises:
a support frame having an outer perimeter, wherein the pet support surface is operably attached to the support frame; and
a plurality of support legs extending from the support frame.

3. The modular pet furniture of claim 2, wherein at least one of the horizontal support members has a nonterminal aperture formed therein and wherein the aperture receives one of the support legs.

4. The modular pet furniture of claim 1, wherein the pet support surface is removably attached to the attachment means.

5. The modular pet furniture of claim 1, and further comprising a pet enclosure mounted with respect to the pet support surface to at least partially enclose the pet support surface.

6. The modular pet furniture of claim 1, wherein the pet support surface is fabricated from fabricate or plastic.

7. The modular pet furniture of claim 1, wherein the vertical support members and the horizontal support members are secured to the joint members with solvent cement, twist lock connectors, or set-screw fittings.

8. The modular pet furniture of claim 1 wherein the vertical support members, the horizontal support members, and the joint members are fabricated from plastic, wood, metal, or combinations thereof.

9. The modular pet furniture of claim 1, wherein the attachment mechanism allows the pet support structure to be selectively positioned with respect to the frame structure.

10. A pet furniture frame structure comprising;
a plurality of vertical support members, each vertical support member having an insertion end;
a plurality of horizontal support members, each horizontal support member having an insertion end, at least one of said horizontal support members defining a nonterminal aperture;
a plurality of joint members accommodating the insertion ends of the vertical support members and the horizontal support members therewithin, thereby interconnecting the vertical support members and the horizontal support members to form an array of support regions; and
a plurality of pet support surfaces removably attached in the support regions.

11. The pet furniture frame structure of claim 10, wherein a bed structure is removably mounted in the support region.

12. The pet furniture frame structure of claim 10, wherein a scratch pad is removably mounted in the support region.

13. A method of forming modular pet furniture comprising:
interconnecting a plurality of horizontal support members and a plurality of vertical support members using a plurality of joint members accommodating insertion ends of the horizontal support members and vertical support members therewithin, thereby forming a frame;
attaching a bed structure to at least one horizontal support member; and
fastening a pet support to the bed structure.

14. The method of forming modular pet furniture according to claim 13, further comprising attaching a fabric to at least one horizontal cross member to form a scratch pad.

15. The method of forming modular pet furniture according to claim 13, and further comprising attaching a platform to the top of the modular pet bed frame.
